(19) United States
(12) Patent Application Publication
(10) Pub. No.: US 2024/0097136 A1
(43) Pub. Date: Mar. 21, 2024

(54) NEGATIVE ELECTRODE FOR USE IN LITHIUM-ION SECONDARY BATTERY AND LITHIUM-ION SECONDARY BATTERY

(71) Applicants: TOYOTA JIDOSHA KABUSHIKI KAISHA, Aichi-ken (JP); KANSAI PAINT CO., LTD., Hyogo-ken (JP)

(72) Inventors: Akira KOHYAMA, Aichi-ken (JP); Ryuta MORISHIMA, Aichi-ken (JP); Daisaku ITO, Kanagawa-ken (JP); Naoyuki IWATA, Kanagawa-ken (JP)

(73) Assignees: TOYOTA JIDOSHA KABUSHIKI KAISHA, Aichi-ken (JP); KANSAI PAINT CO., LTD., Hyogo-ken (JP)

(21) Appl. No.: 18/274,335

(22) PCT Filed: Jan. 27, 2022
(86) PCT No.: PCT/JP2022/002975

§ 371 Date: Jul. 26, 2023

(30) Foreign Application Priority Data
Jan. 29, 2021 (JP) 2021-013372

(51) Int. Cl. H01M 4/62; H01M 4/38; H01M 10/0525

(52) U.S. Cl. CPC H01M 4/622; H01M 4/386; H01M 10/0525; H01M 2004/027

(57) ABSTRACT

The present disclosure provides a negative electrode for use in a lithium-ion secondary battery capable of protecting the negative electrode from breakage and cracks due to expansion and contraction of an Si-based negative electrode active material. The negative electrode is for use in a lithium-ion secondary battery and includes a negative electrode current collector and a negative electrode active material layer formed on the negative electrode current collector. The negative electrode active material layer contains, as a negative electrode active material, an Si-based negative electrode active material including Si as a component and capable of reversibly absorbing and releasing lithium ions. The negative electrode further includes a high-molecular-weight organic compound for improving durability of the lithium-ion secondary battery. The high-molecular-weight organic compound has a weight-average molecular weight of 1000 or higher.

### TECHNICAL FIELD

The present disclosure relates to a negative electrode for use in a lithium-ion secondary battery and a lithium-ion secondary battery. Specifically, the present disclosure relates to a negative electrode for use in a lithium-ion secondary battery, containing a high-molecular-weight organic compound. The present application is based upon and claims the benefit of priority from Japanese patent application No. 2021-13372 filed on Jan. 29, 2021, and the entire disclosure of which is incorporated herein its entirety by reference.

### BACKGROUND ART

Since lithium-ion secondary batteries are lightweight and provide high energy density, they are used widely as portable power sources for personal computers, mobile terminals, and the like, and as power sources for driving vehicles such as battery electric vehicles (BEV), hybrid electric vehicles (HEV), and plug-in hybrid electric vehicles (PHEV).

In recent years, lithium-ion secondary batteries are expected to utilize Si-based materials as negative-electrode active materials in order to further increase capacity. Graphite has been used as a negative electrode active material, but Si-based materials are known to have a theoretical capacity density five times or more greater than graphite, and their application as a new negative electrode active material to replace graphite is under consideration.

However, the negative electrode active material containing a Si-based material (hereinafter referred to as a Si-based anode active material) has a high theoretical capacity density, but has a property that its volume changes significantly during charging and discharging. Such a property may cause breakage or cracking in the negative electrode active material layer formed on a negative electrode current collector. Isolation of portions where such breakage or cracking occurs from a current collector network may reduce battery life. At the same time, a solid electrolyte interphase (SEI) film formed on the surface of a negative electrode may crack, causing lithium ions in the electrolyte to be taken up to re-form a SEI film, resulting in electrolyte degradation.

### CITATION LIST

### Patent Literatures

Patent Literature 1: Japanese Patent No. 5158460
Patent Literature 2: Japanese Patent No. 5809200
Patent Literature 3: Japanese Patent Application Publication No. 2014-197551
Patent Literature 4: Japanese Patent Application Publication No. 2014-224028

### SUMMARY OF INVENTION

To address these problems, various methods have been proposed to suppress the expansion and contraction of the Si-based negative electrode active material. For example, Patent Literature 1 discloses a method of forming voids in the negative electrode to follow the expansion and contraction of Si fine powder, Patent Literature 2 discloses a method of uniformly dispersing a Si compound and electroconductive carbon, Patent Literature 3 discloses a method of doping graphite with Si particles, and Patent Literature 4 discloses a method of forming a carbide film on a Si core.

Although the above method can substantially prevent breakage and cracking occurred in the negative electrode active material layer due to expansion and contraction of the Si-based negative electrode active material, there is room for further improvement in the problem of maintaining durability of the battery.

The present disclosure was made in view of the circumstances, and is intended to provide a negative electrode for use in a lithium-ion secondary battery capable of protecting the negative electrode active material from breakage and cracks due to expansion and contraction of the Si-based negative electrode active material and withstanding repeated charging/discharging. The present disclosure is intended to further provide a lithium-ion secondary battery using the negative electrode disclosed herein.

The negative electrode used in the lithium-ion secondary battery disclosed herein includes: a negative electrode current collector; and a negative electrode active material layer formed on the negative electrode current collector. The negative electrode active material layer contains, as a negative electrode active material, an Si-based negative electrode active material containing Si as a component and capable of reversibly absorbing and releasing lithium ions, and a high-molecular-weight organic compound having a weight-average molecular weight of 1000 or higher, capable of improving durability of the lithium-ion secondary battery (hereinafter also referred to as a durability improver).

The negative electrode contains the high-molecular-weight organic compound in the negative electrode active material layer. With such a configuration, the high-molecular-weight organic compound is adsorbed to the surface of the negative electrode active material layer, and the surface of the negative electrode active material layer can be protected from expansion and contraction of the Si-based negative electrode active material.

In one suitable embodiment, the high-molecular-weight organic compound added to the negative electrode has at least one polar functional group selected from the group consisting of an amino group, a sulfonate group, a carboxyl group, a phosphate group, a polyalkylene ether group, an amide group, a hydroxyl group, an epoxy group, and an alkoxysilyl group, a concentration of the polar functional group is 0.1 mmol/g or higher, the high-molecular-weight organic compound has at least one ionic functional group selected from the group consisting of an amino group, a sulfonate group, a carboxyl group, a phosphate group, and an amide group, and a concentration of the ionic functional group is 0.1 mmol/g or higher, and the high-molecular-weight organic encompasses a copolymer compound obtained by copolymerization of a polymerizable unsaturated monomer.

With such a configuration, the surface of the negative electrode active material layer can be suitably protected from expansion and contraction of the Si-based negative electrode active material.

In order to achieve the objective, the present disclosure further provides a negative electrode for use in a lithium-ion secondary battery, containing the high-molecular-weight organic compound disclosed herein added. With such a configuration, the negative electrode is protected from cracks and breakage due to expansion and contraction and the Si-based negative electrode active material, thereby improving durability of the lithium-ion secondary battery.

### BRIEF DESCRIPTION OF DRAWINGS

FIG. 1 is a schematic section view of an example configuration of a lithium-ion secondary battery using a negative electrode according to an embodiment.

FIG. 2 is a schematic view of a configuration of a wound electrode assembly of a lithium-ion secondary battery using the negative electrode according to the embodiment.

### DESCRIPTION OF EMBODIMENTS

An embodiment of the present disclosure will be described below. The matters necessary for executing the present disclosure, except for matters specifically herein referred to can be grasped as design matters of a person skilled in the art based on the related art in the preset field. The disclosure can be executed based on the contents disclosed herein and the technical knowledge in the present field.

The expression “A to B (here A and B are any numerical values)” indicating herein a numerical range means “from A to B inclusive,” which is the same as the general meaning.

The “secondary battery” herein indicates an electricity storage device that can be repeatedly charged and discharged, and encompasses so-called secondary batteries and electricity storage elements such as electric double-layer capacitors. The “lithium-ion secondary battery” herein indicates a secondary battery which uses lithium ions as electric charge carriers and achieves charging and discharging by movement of electric charges associated with the lithium ions between positive and negative electrodes.

A negative electrode for use in a lithium-ion battery, according to the present embodiment, includes: a negative electrode current collector and a negative electrode active material layer formed on the negative electrode current collector. The negative electrode active material layer includes, as a negative electrode active material, an Si-based negative electrode active material containing Si as a component and capable of reversibly absorbing and releasing lithium ions. The negative electrode active material layer further includes a high-molecular-weight organic compound added capable of improving durability of the lithium-ion secondary battery to be described later. The “durability” herein means a long-life performance of withstanding a decrease in battery capacity due to charging/discharging of the lithium-ion secondary battery.

As the negative electrode current collector, a foil-like body made of a metal having favorable electroconductivity (such as copper, nickel, titanium, stainless steel) can be used, and a copper foil is preferably used.

The Si-based negative electrode active material contained in the negative electrode active material layer can be, for example, SiO or Si, which contains Si as a component and is capable of storing and releasing lithium ions. Note that the negative electrode active material contained in the negative electrode active material layer is not limited to the Si-based negative electrode active material, and can be a carbon-based negative electrode active material layer such as graphite (natural graphite, artificial graphite), and low crystalline carbon (hard carbon, soft carbon).

The negative electrode active material layer may further include a component other than the active material, such as a binder and a thickener, besides the negative electrode active material layer and the durability improver, as long as the effect of the present disclosure is not significantly impaired. Examples of the binder used include styrene-butadiene rubber (SBR). Examples of the thickener used include carboxymethyl cellulose (CMC).

In the negative electrode active material layer (negative electrode layer), the amount of the negative electrode active material added is, in a solid content, usually 50 mass % to 99.8 mass %, preferably 80 mass % to 99 mass %, the amount of the binder added is, in a solid content, usually 0.05 mass % to 10 mass %, preferably 0.1 mass % to 5.0 mass %, and the amount of the thickener added is, in a solid content, usually 0.05 to 10 mass %, preferably 0.1 mass % to 5.0 mass %, relative to 100 mass % of the solid content of the negative electrode layer.

The negative electrode for use in a lithium-ion battery, according to the present embodiment, can be produced by known methods. For example, a negative electrode active material, a binder, a thickener, and a solvent are mixed, and a durability improver to be described later is further added to the resultant mixture, thereby preparing a negative electrode mixture paste. The negative electrode mixture paste is applied to a negative electrode current collector, which is then dried, thereby producing a negative electrode. The mixing, applying, and drying are performed by known methods.

The solvent used is preferably an aqueous solvent. The aqueous solvent can be any solvent exhibiting aqueous properties as a whole, and water or a water-based solvent mixture may be used preferably. The “paste” herein is used as a term also encompassing the forms of “slurry” and “ink”.

The amount of the high-molecular-weight organic compound in the negative electrode according to the present embodiment is not particularly limited as long as the effect of the present disclosure is exhibited. If the amount added is too low, it is difficult to obtain the effect of the present disclosure. The amount added is thus preferably 0.01 mass % to 10 mass %, for example, 0.1 mass % to 5 mass %, or 0.6 mass % to 1.5 mass %, relative to 100 mass % of the solid content of the negative electrode mixture paste before mixing the durability improver.

When the high-molecular-weight organic compound (resin) contains a monomer X as its raw material herein, the high-molecular-weight organic compound (resin) is a (co)polymer of the raw material monomer including the monomer X. The (co)polymer herein means a polymer or copolymer.

The “(meth)acrylate” herein means acrylate and/or methacrylate, and “(meth)acrylic acid” herein means acrylic acid and/or methacrylic acid. Further, “(meth)acryloyl” means acryloyl and/or methacryloyl. The “(meth)acrylamide” means acrylamide and/or methacrylamide.

<High-Molecular-Weight Organic Compound>

The durability improver added to the negative electrode active material layer used is usually a high-molecular-weight organic compound having a weight-average molecular weight of 1000 or higher. In light of battery capacity retention rate, the weight-average molecular weight of the high-molecular-weight organic compound is preferably 1000 to 100000, more preferably 2000 to 50000, yet more preferably 3000 to 30000.

The number average molecular weight and the weight average molecular weight are obtained by converting the retention time (retention volume) of polystyrene measured by gel permeation chromatograph (GPC) into the molecular weight of the polystyrene by the retention time (retention volume) of standard polystyrene with known molecular weight, measured under the same conditions. Specifically, “HLC8120GPC” (trade name, manufactured by Tosoh) is used as the gel permeation chromatograph, and four columns of “TSKgel G-4000HXL,” “TSKgel G-3000HXL,” “TSKgel G-2500HXL,” and “TSKgel G-2000HXL” (trade names, all manufactured by Tosoh) are used as columns, and measurements can be performed under conditions where the mobile phase is tetrahydrofuran, the measurement temperature is 40° C., the flow rate is 1 mL/min, and the detector is RI.

The type of the high-molecular-weight organic compound is not particularly limited, specific examples thereof include acrylic resin, polyester resin, epoxy resin, polyether resin, alkyd resin, urethan resin, silicone resin, polycarbonate resin, silicate resin, chlorine-based resin, fluorine-based resin, polyvinyl alcohol, polyvinyl acetal, polyvinylpyrrolidone, and composite resins thereof, and one type of them may be used alone, or two or more types of them may be used in combination.

In particular, in light of the battery capacity retention rate, stability in the negative electrode mixture paste, adsorbability to the negative electrode active material, and the like, the high-molecular-weight organic compound preferably has a polar functional group, and the polar functional group is preferably at least one polar functional group selected from the group consisting of an amino group, a sulfonate group, a carboxyl group, a phosphate group, a polyalkylene ether group, an amide group, a hydroxyl group, an epoxy group, and an alkoxysilyl group.

The concentration of the polar functional group in the high-molecular-weight organic compound is usually 0.1 mmol/g or higher, preferably 1 mmol/g to 30 mmol/g, more preferably 2 mmol/g to 25 mmol/g, yet more preferably 5 mmol/g to 22 mmol/g in light of the battery capacity retention rate.

In particular, the concentration of an ionic polar functional group is usually 0.1 mmol/g or higher, preferably 0.2 mmol/g to 25 mmol/g, more preferably 0.3 mmol/g to 10 mmol/g in light of the battery capacity retention rate.

The concentration of the polar functional group herein is calculated based on the number of the polar functional group in the polymerizable unsaturated monomer. For example, when one polymerizable unsaturated monomer has two polar functional groups, the concentration of the polar functional groups is calculated based on the two polar functional groups.

The high-molecular-weight organic compound is preferably a hydrophilic (highly-polar) compound by the polar functional group, and is preferably soluble in water. The expression “being soluble in water” herein means that when mixed in water to make an aqueous 5% solution, it is in a dissolved or semi-dissolved state, not in an emulsified state.

In particular, in light of the battery capacity retention rate, stability in the negative electrode mixture paste, and adsorbability to the negative electrode active material, the high-molecular-weight organic compound preferably includes a copolymer compound of a polymerizable unsaturated monomer.

<Copolymer Compound>

As a polymerizable unsaturated monomer used as a raw material of the copolymer compound, any monomer having a polymerizable unsaturated group that can undergo radical polymerization can be used without particular limitations. Examples of the polymerizable unsaturated group include a (meth)acryloyl group, a (meth)acrylamide group, a vinyl group, an allyl group, a (meth)acryloyloxy group, and a vinylether group.

In particular, in light of the battery capacity retention rate, stability in the negative electrode mixture paste, and adsorbability to the negative electrode active material, the copolymer compound preferably contains a copolymer of a polymerizable unsaturated monomer having a polar functional group as a component. The polar functional group is preferably at least one polar functional group selected from the group consisting of an amide group, a sulfonate group, a carboxyl group, a phosphate group, a polyalkylene ether group, an amide group, and a hydroxyl group.

<Polymerizable Unsaturated Monomer Having Polar Functional Group>

Examples of the polymerizable unsaturated monomer having the polar functional group include: hydroxyl group-containing polymerizable unsaturated monomers such as monoesterified products of (meth)acrylic acid such as 2-hydroxyethyl (meth)acrylate, 2-hydroxypropyl (meth)acrylate, 3-hydroxypropyl (meth)acrylate, and 4-hydroxybutyl (meth)acrylate and alcohol with 2 to 8 carbon atoms, ε-caprolactone denatured bodies of the monoesterified products of the (meth)acrylic acid and the alcohol with 2 to 8 carbon atoms, N-hydroxymethyl (meth)acrylamide, allyl alcohol, and (meth)acrylate having a polyoxyalkylene chain with a hydroxyl group at the molecular end; carboxyl group-containing polymerizable unsaturated monomers such as (meth)acrylic acid, maleic acid, crotonic acid, and β-carboxyethyl acrylate; amino group- and/or amide group-containing polymerizable unsaturated monomers such as (meth)acrylamide, N,N-dimethylaminoethyl (meth)acrylate, N,N-diethylaminoethyl (meth)acrylate, N,N-dimethylaminopropyl (meth)acrylamide, and adducts of glycidyl (meth)acrylate and amines; polymerizable unsaturated monomers having an urethan bond such as a reaction product of an isocyanate group-containing polymerizable unsaturated monomer and a hydroxyl group-containing compound or a reaction product of a hydroxyl group-containing polymerizable unsaturated monomer and an isocyanate group-containing compound; epoxy group-containing polymerizable unsaturated monomers such as glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether; (meth)acrylate having a polyoxyethylene chain with an alkoxy group at the molecular end; sulfonate group-containing polymerizable unsaturated monomers such as 2-acrylamide-2-methylpropanesulfonic acid, 2-sulfoethyl (meth)acrylate, allyl sulfonic acid, 4-styrene sulfonic acid, and sodium salts and ammonium salts of these sulfonic acids; phosphate group-containing polymerizable unsaturated monomers such as 2-acryloyloxyethyl acid phosphate, 2-methacryloyloxyethyl acid phosphate, 2-acryloyloxypropyl acid phosphate, and 2-methacryloyloxypropyl acid phosphate; alkoxysilyl group-containing polymerizable unsaturated monomers such as trimethoxyvinylsilane, vinyltriethoxysilane, vinyl tris(2-methoxyethoxy) silane, γ-(meth)acryloyloxypropyltrimethoxysilane, γ-(meth)acryloyloxypropyltrimethoxysilane; polyalkylene ether group-containing polymerizable unsaturated monomers represented by the following formula (1) such as polyethylene glycol (meth)acrylate, polypropylene glycol (meth)acrylate, methoxypolyethylene glycol (meth)acrylate, and ethoxypolyethylene glycol (meth)acrylate;

CH₂═C(R₁)COO(CₙH₂ₙO)ₘ—R₂ (1)

[In the formula (1), “R₁” represents a hydrogen atom or CH₃, “R₂” represents a hydrogen atom or an alkyl group with 1 to 4 carbon atoms, “m” is an integer of 4 to 60, particularly 4 to 55, and “n” is an integer of 2 to 3, wherein m oxyalkylene units (CₙH₂ₙO) may be the same or different from each other.]

These polymerizable unsaturated monomers may be used alone or in combination of two or more of them. In light of the battery capacity retention rate, the polymerizable unsaturated monomer preferably has an ionic functional group and/or polyalkylene ether group, more preferably has an ionic functional group.

<Other Polymerizable Unsaturated Monomer>

Examples of the polymerizable unsaturated monomer other than the polymerizable unsaturated monomer having the polymerizable unsaturated monomer include: alkyl or cycloalkyl (meth)acrylates such as alkyl (meth)acrylates with equal to or lower than 3 carbon atoms such as methyl (meth)acrylate, ethyl (meth)acrylate, n-propyl (meth)acrylate, and isopropyl (meth)acrylate, n-butyl (meth)acrylate, i-butyl (meth)acrylate, t-butyl(meth)acrylate, n-hexyl (meth)acrylate, octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methycyclohexyl (meth)acrylate, t-butylcyclohexyl (meth)acrylate, cyclododecyl(meth)acrylate, and tricyclodecanyl (meth)acrylate; polymerizable unsaturated compounds having an isobornyl group such as isobornyl (meth)acrylate; polymerizable unsaturated compounds having an adamantyl group such as adamantyl (meth)acrylate; aromatic ring-containing polymerizable unsaturated monomers such as benzyl (meth)acrylate, styrene, α-methylstyrene, and vinyltoluene; and polymerizable unsaturated monomers having at least two polymerizable unsaturated groups in one molecule, such as allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butane diol di(meth)acrylate, neopentyl glycol di(meth)acrylate, 1,6-hexane diol di(meth)acrylate, pentaerythritol di(meth)acrylate, pentaerythritol tetra(meth)acrylate, glycerol di(meth)acrylate, 1,1,1-trishydroxymethylethane di(meth)acrylate, 1,1,1-trishydroxymethylethane tri(meth)acrylate, 1,1,1-trishydroxymethylpropane tri(meth)acrylate, triallyl isocyanurate, diallyl phthalate, and divinylbenzene. These polymerizable unsaturated monomers may be used alone or in combination of two or more of them.

<Polymerization Method>

The polymerization method for a copolymer compound can be a known method. For example, the copolymer compound can be produced by solution polymerization of a polymerizable unsaturated monomer in an organic solvent without limitations, and for example, bulk polymerization, emulsion polymerization, or suspension polymerization can be used. When solution polymerization is performed, it may be continuous or batch polymerization, and the polymerizable unsaturated monomer may be used at once or divided and used individually, or added continuously or intermittently.

A radical polymerization initiator used for the polymerization can be a known polymerization method. Examples of the radical polymerization initiator include peroxide-based polymerization initiators such as cyclohexanone peroxide, 3,3,5-trimethyl cyclohexanone peroxide, methyl cyclohexanone peroxide, 1,1-bis(tert-butylperoxy)-3,3,5-trimethylcyclohexane, 1,1-bis(tert-butylperoxy)cyclohexane, n-butyl-4,4-bis(tert-butylperoxy)valerate, cumene hydroperoxide, 2,5-dimethylhexane-2,5-dihydroperoxide, 1,3-bis(tert-butylperoxy-m-isopropyl)benzene, 2,5-dimethyl-2,5-di(tertbutylperoxy)hexane, diisopropylbenzene peroxide, tert-butylcumyl peroxide, decanoyl peroxide, lauroyl peroxide, benzoyl peroxide,2,4-dichlorobenzoyl peroxide, di-tert-amyl peroxide, bis(tert-butylcyclohexyl)peroxy dicarbonate, tert-butylperoxy benzoate, 2,5-dimethyl-2,5-di(benzoylperoxy)hexane, and tert-butylperoxy-2-ethylhexanoate; azo-based polymerization initiators such as 2,2′-azobis(isobutyronitrile), 1,1-azobis(cyclohexane-1-carbonitril), azo cumene, 2,2′-azobis(2-methylbutylonitrile), 2,2′-azobis dimethylvaleronitrile, 4,4′-azobis(4-cyanovaleric acid), 2-(t-butylazo)-2-cyanopropane, 2,2′-azobis(2,4,4-trimethylpentane), 2,2′-azobis(2-methylpropane), and dimethyl 2,2′-azobis(2-methylpropionate). These radical polymerization initiators may be used alone or in combination of two or more of them.

A solvent used for polymerization is not particularly limited, and can be water, an organic solvent, or a mixture thereof. Examples of the organic solvent include: known solvents such as hydrocarbon solvents such as n-butane, n-hexane, n-heptane, n-octane, cyclopentane, cyclohexane, and cyclobutane; aromatic solvents such as toluene and xylene; ketone-based solvents such as methyl isobutyl ketone; ether-based solvents such as n-butylether, dioxane, ethylene glycol monomethyl ether, ethylene glycol monoethyl ether, ethylene glycol monobutyl ether, and diethylene glycol; ester-based solvents such as ethyl acetate, n-butyl acetate, isobutyl acetate, ethylene glycol monomethyl ether acetate, and butyl carbitol acetate; ketone-based solvents such as methyl ethyl ketone, methyl isobutyl ketone, and diisobutylketone; alcohol-based solvents such as ethanol, isopropanol, n-butanol, sec-butanol, and isobutanol; amide-based solvents such as Equamide (trade name, manufactured by Idemitsu Kosan Co., Ltd.), N,N-dimethylformamide, N,N-dimethylacetamide, N-methylformamide, N-methylacetamide, N-methylpropypamide, and N-methyl-2-pyrrolidone.

Among them, the solvent preferably does not include water, and preferably includes at least one carbonate-based solvent selected from the group consisting of diethyl carbonate, ethyl methyl carbonate, dimethyl carbonate, and propylene carbonate. These solvents may be used alone or in combination of two or more of them.

In the solution polymerization in an organic solvent, for example, used is a method in which a polymerization initiator, a polymerizable unsaturated monomer component, and an organic solvent are mixed and heated while stirring, or a method in which an organic solvent is introduced into a reaction vessel to reduce the temperature increase in the system due to reaction heat, and a polymerizable unsaturated monomer component and a polymerization initiator are then added drowise separately or in combination over a predetermined time with stirring at a temperature of 60° C. to 200° C. while optionally blowing in an inactive gas such as nitrogen and argon.

Polymerization can generally be performed for 1 hour to 10 hours. After each stage of polymerization, an additional catalyst stage of heating the reaction vessel while the polymerization initiator is added dropwise may be provided if necessary.

In light of adsorption to Si-based negative electrode active material and stability, the copolymer compound particularly preferably has a graft structure or block structure, which is divided into two segments, an adsorption part and a steric repulsion part, especially a graft structure (comb structure).

In light of compatibility with electrolyte, the graft structure has an ionic functional group in the adsorption part, which is a main chain, and a hydrophilic functional group in a steric repulsion part, which is a side chain.

The hydrophilic functional group in the side chain can be suitably an ionic functional group or a nonionic functional group, and the copolymer compound preferably has at least one nonionic functional group among them.

The steric repulsion part in the side chain has a weight-average molecular weight of preferably 200 to 30000, more preferably 300 to 10000, yet more preferably 400 to 10000.

The mass ratio between the main chain and the side chain is preferably 1/99 to 99/1, more preferably 5/95 to 95/5, yet more preferably 5/95 to 50/50.

A method for introducing a steric repulsion part as a side chain into the copolymer compound can be suitably a method known per se, and specific examples thereof include a method in which a polymerizable unsaturated group-containing macromonomer which is a side chain and another polymerizable unsaturated group-containing monomer are copolymerized by the above-mentioned polymerization method, and a method in which the polymerizable unsaturated group-containing monomer is copolymerized, and a compound which is a side chain is added. Any of these methods is suitably used.

The polymerizable unsaturated group-containing macromonomer can be produced by a method known per se. For example, Japanese Examined Patent Application Publication No. S43-11224 describes a method in which a carboxylate group is introduced into the end of the polymer chain using a chain-transfer agent such as mercaptopropionic acid in the process of producing a macromonomer, and glycidyl methacrylate is then added to introduce an ethylenically unsaturated group, thereby obtaining a macromonomer. Japanese Examined Patent Application Publication Nos. H6-23209 and H7-35411 disclose a method by catalyst chain transfer polymerization (CCTP) using a cobalt complex. Japanese Unexamined Patent Application Publication No. H7-002954 describes a method in which methacrylic acid is subjected to radical polymerization using, as an addition-fragmentation chain-transfer agent, 2,4-diphenyl-4-methyl-1-pentene, thereby obtaining a macromonomer.

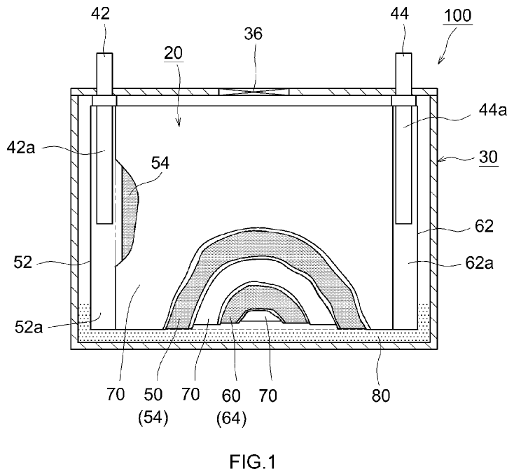

FIG. 1 schematically illustrates an internal structure of a lithium-ion secondary battery 100 using the negative electrode according to an embodiment.

The lithium-ion secondary battery 100 is a sealed battery constructed by housing a flat wound electrode assembly 20 and a nonaqueous electrolyte 80 in a square battery case 30. The battery case 30 includes a positive electrode terminal 42 and negative electrode terminal 44 for external connection, and a thin-walled safety valve 36 set to release an internal pressure of the battery case 30 when the internal pressure increases to a predetermined level or higher. The battery case 30 is provided with an inlet (not shown) for introducing the nonaqueous electrolyte. The positive electrode terminal 42 is electrically connected to a positive electrode current collector 42a. The negative electrode terminal 44 is electrically connected to a negative electrode current collector 44a. As the material of the battery case 30, a metal material which is light and has high thermal conductivity, such as aluminum can be used, for example.

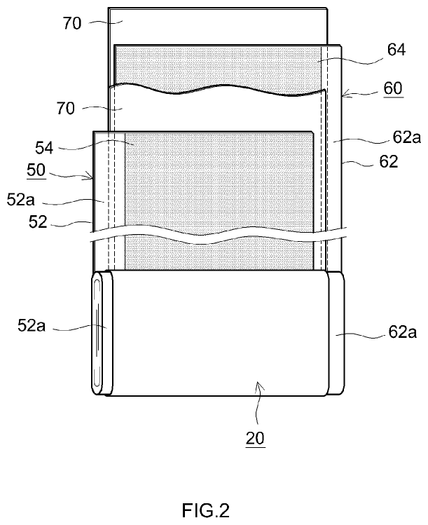

FIG. 2 schematically illustrates a configuration of an electrode assembly 20 of the lithium-ion secondary battery 100 according to the embodiment.

The wound electrode assembly 20 has a configuration in which a sheet-like positive electrode 50 in which a positive electrode active material layer 54 is provided on one or both surfaces of a long positive electrode current collector 52 along the longitudinal direction and a negative electrode 60 in which a negative electrode active material layer 64 is provided on one or both surfaces of a long negative electrode current collector 62 in the longitudinal direction are stacked on each other via two long separators 70 along the longitudinal direction. A positive electrode current collector 42a and a negative electrode current collector 44a are bonded to a portion 52a where the positive electrode active material layer is not formed and a portion 62a where the negative electrode active material layer is not formed formed to extend outward from both ends of the wound electrode assembly 20.

Note that it is not at all necessary to limit the electrode assembly to the wound type as shown in FIG. 2 when the present disclosure is implemented. For example, the lithium-ion secondary battery 100 may include a stacked electrode assembly where multiple sheet-like positive electrodes and multiple sheet-like negative electrodes are stacked via separators. As can be seen from the technical information disclosed herein, the shape of the battery is also not limited to a square shape.

The negative electrode 60 used is a negative electrode 60 for use in a lithium-ion secondary battery according to the embodiment. The positive electrode 50 used may be any known lithium-ion secondary battery without particular limitations. A typical positive electrode 50 is shown below.

Examples of the positive electrode collector foil 52 constituting the positive electrode 50 include an aluminum foil. Examples of the positive electrode active material included in the positive electrode active material layer 54 include lithium transition metal oxide (such as LiNi_{1/3}Co_{1/3}Mn_{1/3}O₂, LiNiO₂, LiCoO₂, LiFeO₂, LiMn₂O₄, LiNi_{0.5}Mn_{1.5}O₄) and lithium transition metal phosphate compound (such as LiFePO₄). The positive electrode active material layer 54 may further contain, for example, a component such as an electroconductive material and a binder, besides the active material. The electroconductive material suitably used may be, for example, carbon black such as acetylene black (AB) and other carbon materials (e.g., graphite). The binder used may be, for example, polyvinylidene fluoride (PVdF).

The separator 70 used may be any of various microporous sheets which are similar to those used in a lithium-ion secondary battery, and examples thereof include microporous resin sheets made of resin such as polyethylene (PE) and polypropylene (PP). Such a microporous resin sheet may have a monolayer structure, or a lamination structure of two or more layers (e.g., a three-layer structure where PP layers are stacked on both surfaces of a PE layer). The separator 70 may include a heat-resistance layer (HRL).

The nonaqueous electrolyte 80 may contain a nonaqueous solvent and a supporting electrolyte. The nonaqueous solvent used can be any of organic solvents such as various carbonates, ethers, esters, nitriles, sulfones, and lactones, which are used in an electrolyte of commonly used lithium-ion secondary batteries, without particular limitations. Specific examples thereof include ethylene carbonate (EC), propylene carbonate (PC), diethyl carbonate (DEC), dimethyl carbonate (DMC), ethyl methyl carbonate (EMC), monofluoro ethylene carbonate (MFEC), difluoro ethylene carbonate (DFEC), monofluoromethyl difluoromethyl carbonate (F-DMC), and trifluorodimethyl carbonate (TFDMC). These nonaqueous solvents may be used alone or in combination of two or more of them, as appropriate. Examples of the supporting electrolyte used include lithium salts such as LiPF₆, LiBF₄, and LiClO₄ (preferably, LiPF₆). The concentration of the supporting electrolyte is preferably from 0.7 mol/L to 1.3 mol/L or less inclusive.

The nonaqueous electrolyte 80 may further contain, for example, various additives such as a gas generating agent, namely biphenyl (BP) and cyclohexyl benzene (CHB); and a thickener, in addition to the components mentioned above, as long as the effect of the nonaqueous electrolyte is not significantly impaired.

The above description of the configuration, components, and the like of the lithium-ion secondary battery is general and does not particularly characterize the present disclosure, so further detailed description and illustrations are omitted. A person skilled in the art can easily construct lithium-ion secondary batteries and other secondary batteries of various forms and sizes by employing knon materials and production processes, except for adding the durability improver disclosed herein to the negative electrode active material.

The lithium-ion secondary battery 100 configured as described above can be used for various applications. Suitable applications include power sources for driving, to be mounted on vehicles such as electric vehicles (BEV), hybrid vehicles (HEV), and plug-in hybrid vehicles (PHEV). Typically, the multiple lithium-ion secondary batteries 100 used may be connected in series and/or parallel to be in an assembled battery.

The square lithium-ion secondary battery 100 including the flat wound electrode assembly 20 has been described above as an example. However, the lithium-ion secondary battery can be configured as a lithium-ion secondary battery including a laminated electrode assembly. The lithium-ion secondary battery may also be configured as a cylindrical lithium-ion secondary battery or a laminated lithium-ion secondary battery.

The present disclosure will be further described by the following Examples.

Methods known in the art are used as synthesis methods for various compounds, production methods for secondary batteries, evaluation test methods, and the like. However, it should be understood that the present disclosure is not limited to this, and various modifications and variations are possible within the equivalent range of the technical idea and the scope of the claims of the present disclosure.

The term “parts” herein indicates parts by mass, and the symbol “%” indicates mass %.

<Production of Macromonomer>

(Macromonomer 1)

To a reaction container equipped with a thermometer, a condenser, a nitrogen gas introduction tube, a stirrer, and a dropper, 16 parts of ethylene glycol monobutyl ether and 9.15 parts of 2,4-diphenyl-4-methyl-1-pentene were introduced, and the resultant mixture was then stirred at 160° C. while nitrogen was blown in. Next, a mixture liquid of 100 parts of methacrylamide and 7 parts of di-tertiaryamylperoxide was added dropwise into the resultant mixture over a period of 3 hours, and the mixture was then stirred as it was for 2 hours. Subsequently, the mixture was cooled to 30° C. and diluted with diethyl carbonate, thereby obtaining a hydrophilic macromonomer containing a polymerizable unsaturated group (macromonomer 1) solution with a solid content of 60%. The obtained macromonomer 1 had a weight average molecular weight of 2000 and a concentration of the polar functional group of 11.8 mmol/g.

<Production of High-Molecular-Weight Organic Compound>

(High-Molecular-Weight Organic Compound No. 4)

To a reaction container equipped with a thermometer, a condenser, a nitrogen introduction tube, a stirrer, a dropper, 40 parts of diethyl carbonate was introduced, and air in the reaction container was then replaced with nitrogen and then held at 120° C. To this reaction container, the following monomer mixture was added dropwise over a period of 4 hours.

(Monomer Mixture)
methyl methacrylate: 25 parts
n-butyl acrylate: 25 parts
2-hydroxyethyl acrylate: 50 parts
t-butylperoxy-2-ethylhexanoate (polymerization initiator): 9 parts

After one hour from the end of the dropwise addition, a solution of 0.5 part of t-butylperoxy-2-ethylhexanoate dissolved in 10 parts of diethylcarbonate was added dropwise to the reaction container over a period of 1 hour. After the dropwise addition, the reaction container was held at 120° C. for another 1 hour. Diethyl carbonate was then added so that the solid content became 50%, thereby obtaining a high-molecular-weight organic compound No. 4 with a solid content of 50%. The high-molecular-weight organic compound No. 4 had a weight-average molecular weight of 4000 and a concentration of a polar functional group of 4.3 mmol/g.

(High-Molecular-Weight Organic Compounds Nos. 5 to 15)

High-molecular-weight organic compounds Nos. 5 to 15 were produced in the same manner as for the high-molecular-weight organic compound No. 4 except that the composition of monomers and the polymerization initiators were as shown in the following Table 1.

Table 1 shows the weight-average molecular weight, the concentration of the polar functional group (mmol/g) and the concentration of ionic polar functional group (mmol/g) of each resin.

TABLE 1

| High-molecular- | | | | | | | | | | | | | | | | | |
|---|---|---|---|---|---|---|---|---|---|---|---|---|---|---|---|---|---|
| weight organic | | | | | | | | | | | | | | | | | |
| compound No. | | 1 | 2 | 3 | 4 | 5 | 6 | 7 | 8 | 9 | 10 | 11 | 12 | 13 | 14 | 15 | 16 |
| Mono- | Macro- | Note 3 | Note 4 | Note 5 | | | | | | | 50 | | | | 50 | 50 | Note 6 |
| mer | monomer 1 | | | | | | | | | | | | | | | | |
| (parts) | (Note 1) | | | | | | | | | | | | | | | | |
| | Macro- | | | | | | | | | | | 50 | 25 | 50 | | | |
| | monomer 2 | | | | | | | | | | | | | | | | |
| | (Note 2) | | | | | | | | | | | | | | | | |
| | Methyl | | | | 25 | 40 | 40 | 40 | 35 | 35 | 10 | 25 | 45 | | | | |
| | methacrylate | | | | | | | | | | | | | | | | |
| | n-Butyl | | | | 25 | 40 | 40 | 40 | 35 | 35 | 40 | 25 | 30 | 30 | 30 | 30 | |
| | acrylate | | | | | | | | | | | | | | | | |
| | 2- | | | | 50 | | | | | | | | | | | | |
| | Hydroxyethyl | | | | | | | | | | | | | | | | |
| | ethyl acrylate | | | | | | | | | | | | | | | | |
| | N,N- | | | | | | | 20 | | | | | | 20 | | | |
| | Dimethyl- | | | | | | | | | | | | | | | | |
| | aminoethyl | | | | | | | | | | | | | | | | |
| | methacrylate | | | | | | | | | | | | | | | | |
| | Acrylic acid | | | | | 20 | 20 | | | | | | | | 20 | 20 | |
| | 2-Sulfoethyl | | | | | | | | 30 | | | | | | | | |
| | acrylate | | | | | | | | | | | | | | | | |
| | Methacryloyl- | | | | | | | | | 30 | | | | | | | |
| | oxyethyl | | | | | | | | | | | | | | | | |
| | acid | | | | | | | | | | | | | | | | |
| | phosphate | | | | | | | | | | | | | | | | |

| | | | | | | | | | | | | | | | | |
|---|---|---|---|---|---|---|---|---|---|---|---|---|---|---|---|---|
| t-Butylperoxy-2- | | | | 9 | 9 | 4 | 4 | 4 | 4 | 4 | 4 | 4 | 4 | 4 | 0.5 | |
| ethylhexanoate | | | | | | | | | | | | | | | | |
| (parts) | | | | | | | | | | | | | | | | |
| Weight-average | 2000 | 4000 | 4000 | 4000 | 4000 | 10000 | 10000 | 10000 | 10000 | 10000 | 10000 | 10000 | 10000 | 10000 | 60000 | 500 |
| molecular weight | | | | | | | | | | | | | | | | |
| Concentration | 22.7 | 22.7 | 14.1 | 4.3 | 2.8 | 2.8 | 1.3 | 1.5 | 1.4 | 5.9 | 10.8 | 5.4 | 12.1 | 8.7 | 8.7 | 22.7 |
| (mmol/g) of polar | | | | | | | | | | | | | | | | |
| functional group | | | | | | | | | | | | | | | | |
| Concentration | 0 | 0 | 0 | 0 | 2.8 | 2.8 | 1.3 | 1.5 | 1.4 | 0 | 0 | 0 | 1.3 | 2.8 | 2.8 | 0 |
| (mmol/g) of ionic | | | | | | | | | | | | | | | | |
| polar functional | | | | | | | | | | | | | | | | |
| group | | | | | | | | | | | | | | | | |

(Note 1)
Macromonomer 1: Macromonomer obtained by <Production of Macromonomer>
(Note 2)
Macromonomer 2: Methoxy polyethylene glycol methacrylate (molecular weight: 2000, concentration of polar functional group: 21.6 mmol/g)
(Note 3)
High-molecular-weight organic compound No. 1: Polyethylene glycol (100% of solid content)
(Note 4)
High-molecular-weight organic compound No. 2: Polyvinyl alcohol (99.9% of saponification value, 100% of solid content)
(Note 5)
High-molecular-weight organic compound No. 3: Polyacrylamide (100% of solid content)
(Note 6)
High-molecular-weight organic compound No. 16: Polyethylene glycol (100% of solid content)
Numerical values in Table are amount of active ingredients.

<Production of Nonaqueous Electrolyte Lithium-Ion Secondary Battery>

<Production of Negative Electrode>

### Example 1

A powder mixture of graphite (a mean particle diameter: 20 μm) and SiO (a mean particle diameter: 15 μm) at a ratio of graphite:SiO=95:5 (mass ratio) as a negative electrode active material, a styrene-butadiene copolymer (SBR) as a binder, and carboxymethyl cellulose (CMC) as a thickener were mixed in a ratio of the powder mixture:SBR:CMC=98:1:1 (mass ratio) with water as a dispersion solvent, thereby producing a paste. Then, as a high-molecular-weight organic compound No. 1, 1 mass % polyethylene glycol (the molecular weight: 2000, the concentration of the functional group: 22.7 mmol/g, the solid content: 100%) was mixed relative to the solid content of the paste. The slurry was applied to a copper foil, thereby obtaining a negative electrode.

<Production of Positive Electrode>

A paste where a positive electrode active material (LiNi_{1/3}Co_{1/3}Mn_{1/3}O₂), an electroconductive auxiliary agent (acetylene black), a binder (PVdF) were mixed at a ratio of 87:10:3 (mass ratio) was applied to an aluminum foil, thereby producing a positive electrode.

<Production of Electrolyte>

To a solvent mixture of ethylene carbonate (EC) and ethyl methyl carbonate (EMC) at a volume ratio of 50:50, 1.0 mol/L LiPF₆ which is an electrolyte was dissolved, thereby obtaining a nonaqueous electrolyte.

<Production of Laminated Battery>

The positive electrode and the negative electrode were placed to face each other via a polypropylene/polyethylene/polypropylene trilayer porous film with an air permeability obtained by a Gurley permeability test of 300 seconds, thereby forming an electrode assembly, and the electrode assembly was then sealed with a laminate together with the electrolyte. Thus, a secondary battery (Example 1) was produced.

### Examples 2 to 19

Secondary batteries (Examples 2 to 19) were produced in the same manner as in Example 1 except that high-molecular-weight organic compounds mixed in pastes were as shown in the following Table 2.

Results of evaluation tests are described below. In the present application, if there is even one “X (Fail)” result in the evaluations, the secondary battery is rejected.

<Evaluation Test>

<Activation>

In a thermostatic chamber at 25° C., the initial charging was performed at a current value of 0.3 C up to 4.10 V, followed by discharging at a current value of 0.3 C up to 3.00 V by a constant current method. This was repeated a total of three times.

<Initial Capacity>

By the constant current-constant voltage method, charging was performed at a current value of 0.2 C up to 4.10 V, and low voltage charging was then performed until the current value in the charging at the constant voltage reaches 1/50 C. Thus, the secondary battery was fully charged. Thereafter, by the constant current method, discharging was performed at a current value of 0.2 C up to 3.00 V. The capacity at this time was determined as an initial capacity.

<Capacity Retention Rate (at 25° C.)>

In a thermostatic chamber set at 25° C., 500 cycles of charging and discharging were performed at a current value of 0.5 C. The set value for charging was 4.10 V, and the set value for discharging was 3.00 V. In addition, a 10-minute pause was provided after each end of the charging and discharging. Next, the capacity was measured after the cycle test, and the capacity retention rate was determined by the following equation.

Capacity retention rate (%)=(Battery capacity after 500 cycles/Initial capacity×100.

The evaluation was performed as follows.
Outstanding: The capacity retention rate was 97% or higher and 100% or less.
Excellent: The capacity retention rate was 94% or higher and less than 97%.
Good: The capacity retention rate was 91% or higher and less than 94%.
Not good: The capacity retention rate was less than 91%.

<Capacity Retention Rate (at 60° C.)>

A capacity retention rate was measured in a thermostatic chamber set at 60° C. The measurement was performed in the same manner as for the capacity retention rate at 25° C. except that the temperature set for the thermostatic chamber was changed from 25° C. to 60° C.

TABLE 2

| Examples | | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|---|
| High-molecular-weight | | 1 | 2 | 3 | 4 | 5 | 6 | 7 | 8 | 9 | 10 | 11 | 12 | 13 | | 14 | | 15 | 16 | None |
| organic compound No. | | | | | | | | | | | | | | | | | | | | |
| Content of high- | | 1 | 1 | 1 | 1 | 1 | 1 | 1 | 1 | 1 | 1 | 1 | 1 | 1 | 0.5 | 1 | 0.5 | 1 | 1 | — |
| molecular-weight | | | | | | | | | | | | | | | | | | | | |
| organic compound (%) | | | | | | | | | | | | | | | | | | | | |
| Capacity | 25° C. | Good | Ex- | Ex- | Ex- | Ex- | Ex- | Ex- | Ex- | Ex- | Ex- | Ex- | Ex- | Out- | Out- | Out- | Out- | Out- | Good | Not |
| retention rate | | | cel- | cel- | cel- | cel- | cel- | cel- | cel- | cel- | cel- | cel- | cel- | stand- | stand- | stand- | stand- | stand- | | good |
| evaluation | | | lent | lent | lent | lent | lent | lent | lent | lent | lent | lent | lent | ing | ing | ing | ing | ing | | |
| test (%) | 60° C. | Good | Good | Good | Good | Ex- | Ex- | Ex- | Ex- | Ex- | Ex- | Ex- | Ex- | Out- | Ex- | Out- | Ex- | Ex- | Not | Not |
| | | | | | | cel- | cel- | cel- | cel- | cel- | cel- | cel- | cel- | stand- | cel- | stand- | cel- | cel- | good | good |
| | | | | | | lent | lent | lent | lent | lent | lent | lent | lent | ing | lent | ing | lent | lent | | |

As can be seen from results of comparisons among Examples 1 to 17, 18, and 19, when the Si-based negative electrode in the lithium-ion secondary battery contains the high-molecular-weight organic compound disclosed herein, the reduction in capacity retention rate of the lithium-ion secondary battery can be suppressed.

Although specific examples of the present disclosure have been described in detail above, they are mere examples and does not limit the appended claims. The technology described is the appended claims include various modifications and changes of the foregoing specific examples.

1. A negative electrode for use in a lithium-ion secondary battery, the negative electrode comprising:
a negative electrode current collector; and
a negative electrode active material layer formed on the negative electrode current collector, wherein
the negative electrode active material layer includes, as a negative electrode active material, an Si-based negative electrode active material including Si as a component and capable of reversibly absorbing and releasing lithium ions, and
the negative electrode further comprises a high-molecular-weight organic compound for improving durability of the lithium-ion secondary battery, the high-molecular-weight organic compound having a weight-average molecular weight of 1000 or higher.

2. The negative electrode according to claim 1, wherein
the high-molecular-weight organic compound has a polar functional group,
the polar functional group is at least one polar functional group selected from the group consisting of an amino group, a sulfonate group, a carboxyl group, a phosphate group, a polyalkylene ether group, an amide group, a hydroxyl group, an epoxy group, and an alkoxysilyl group, and
a concentration of the polar functional group is 0.1 mmol/g or higher.

3. The negative electrode according to claim 1, wherein
the high-molecular-weight organic compound has an ionic functional group,
the ionic functional group is at least one selected from the group consisting of an amino group, a sulfonate group, a carboxyl group, a phosphate group, and an amide group, and
a concentration of the ionic functional group is 0.1 mmol/g or higher.

4. The negative electrode according to claim 1, wherein
the high-molecular-weight organic compound includes a copolymer compound of a polymerizable unsaturated monomer.

5. A lithium-ion secondary battery comprising the negative electrode according to claim 1.
